(19) United States
(12) Patent Application Publication
(10) Pub. No.: US 2018/0063599 A1
(43) Pub. Date: Mar. 1, 2018

(54) Method of Displaying Advertisement of 360 VR Video

(71) Applicant: MINKONET CORPORATION, Seoul (KR)

(72) Inventors: Kyung Soo PARK, Gyeonggi-Do (KR); Tae Woo KIM, Gyeonggi-Do (KR); Dong Hwal LEE, Seoul (KR)

(73) Assignee: MINKONET CORPORATION, Seoul (KR)

(21) Appl. No.: 15/247,920

(22) Filed: Aug. 26, 2016

(51) Int. Cl. H04N 21/81; G06T 19/00; G06F 3/01; H04N 21/234; H04N 21/442; H04N 21/433

(52) U.S. Cl. CPC H04N 21/812; G06T 19/006; G06F 3/013; H04N 21/433; H04N 21/816; H04N 21/44218; H04N 21/23424

(57) ABSTRACT

Provided is a method of displaying an advertisement of a 360 VR (virtual reality) video, in which an advertisement is applied to the 360 VR video to be displayed.

According to the method of displaying an advertisement of a 360 VR video, characteristics of a 360 VR video are used to effectively display various advertisement objects in a 360 VR video.

### TECHNICAL FIELD

The present disclosure relates to a method of displaying an advertisement of a 360 VR (virtual reality) video, and more particularly, to a method of displaying an advertisement of a 360 VR video by applying an advertisement to the 360 VR video.

### BACKGROUND ART

Video service providers such as YouTube provide an advertising service by applying advertisements to videos.

In conventional video services, advertisements are shown by adding a banner to a video or inserting an advertisement into a video.

Recently, 360 VR (virtual reality) videos are frequently filmed and made available. A streaming service of such 360 VR videos is also available through various video service providers.

Accordingly, a method of effectively displaying an advertisement in 360 VR videos in a different manner from that for conventional typical videos is required.

### DESCRIPTION OF THE INVENTION

Provided is a method of displaying an advertisement in a 360-degree VR (virtual reality) video. According to an aspect of the present invention, there is provided a method of displaying an advertisement of a 360 VR (virtual reality) video including an advertisement, by using a 360 VR terminal including a 360 VR display device, the method comprising: (a) storing video data in a 360 VR format that is displayable on a virtual spherical screen; (b) storing, as advertisement information, identification numbers of advertisement objects, advertisement contents corresponding to the identification numbers, and advertisement objects defined by advertisement coordinates on the spherical screen, on which the advertisement contents are to be displayed; (c) receiving a gaze direction that the 360 VR display device faces with respect to the spherical screen, from the 360 VR display device; and (d) rendering the video data on the spherical screen to display an image corresponding to a display area corresponding to the gaze direction received in (c), on the 360 VR display device, and displaying advertisement content of an advertisement object having advertisement coordinates located in the display area in locations corresponding to the advertisement coordinates, on the 360 VR display device.

According to the method of displaying an advertisement of a 360 VR video, various advertisement objects are effectively displayed in a 360 VR video by using the characteristics of the 360 VR video.

### BRIEF DESCRIPTION OF THE DRAWINGS

FIG. 1 is a flowchart of a method of displaying an advertisement of a 360 VR video according to an embodiment of the present invention; and

FIG. 2 is a conceptual diagram for describing the method of displaying an advertisement of a 360 VR video illustrated in FIG. 1.

### DETAILED DESCRIPTION OF THE INVENTION

Hereinafter, a method of displaying an advertisement of a 360-degree VR (virtual reality) video according to the present invention will be described more fully with reference to exemplary embodiments of the present invention.

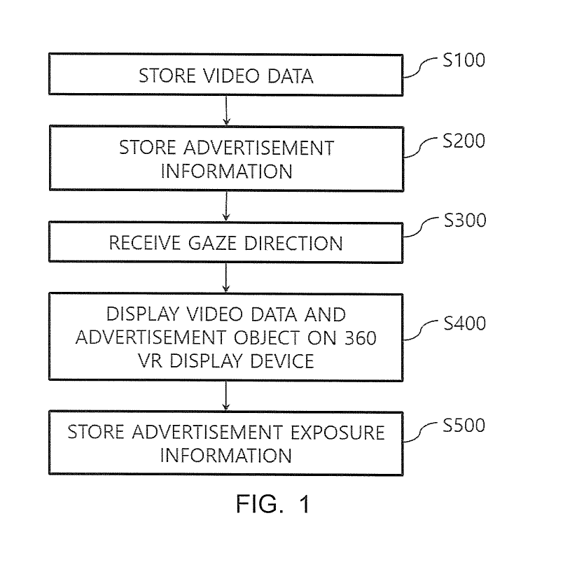

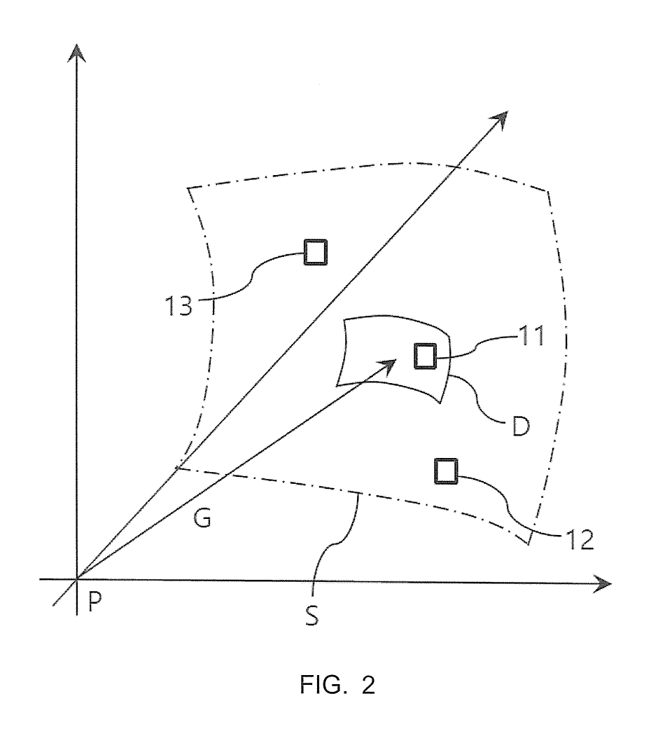

FIG. 1 is a flowchart of a method of displaying an advertisement of a 360 VR video according to an embodiment of the present invention. FIG. 2 is a conceptual diagram for describing the method of displaying an advertisement of a 360 VR video illustrated in FIG. 1.

The present invention relates to a method of displaying advertisement content on a 360 VR video while replaying the 360 VR video by using a 360 VR terminal including a 360 VR display device.

The 360 VR terminal used in the method of displaying an advertisement of a 360 VR video according to the present invention may be a device that is worn on the user's face, such as a head mounted display (HMD), or a mobile device including a typical display device, such as a smartphone.

The method of displaying an advertisement of a 360 VR video according to the present invention is performed by using the 360 VR terminal as described above.

First, the 360 VR terminal stores video data to be displayed on the 360 VR display device in step (a) (step S100). The video data is in a 360 VR format that is displayable on a virtual spherical screen S. The video data may be received through a network to be stored in the 360 VR terminal or may be received using an additional input device to be stored. The video data may be typically a video file that is stored in the form of a set of consecutive image frames over time. According to circumstances, video data whereby image frames may be generated in real time by incorporating objects defined in three-dimensional virtual space and replay data that defines movement of the objects over time to each other may be stored. Video data is defined in a format that is displayable on the virtual spherical screen S as illustrated in FIG. 2.

Next, in step (b) (step S200), the 360 VR terminal stores advertisement information that is to be displayed on the 360 VR display device with the video data. The advertisement information is information about advertisement objects. The advertisement objects are defined by advertisement contents 11, 12, and 13 respectively having identification numbers and advertisement coordinates on the spherical screen S, on which the advertisement contents 11, 12, and 13 are to be displayed. The advertisement contents 11, 12, and 13 may include links to related websites. The advertisement coordinates of the advertisement objects 11, 12, and 13 may be fixed values or may be varied over time.

When the video data and the advertisement information are stored as described above, it is ready to render a video and an advertisement on the spherical screen S.

Next, the 360 VR terminal receives a gaze direction G the 360 VR display device faces, from the 360 VR display device in step (c) (step S300). The 360 VR display device displays an image to be rendered on a portion of the spherical screen S as illustrated in FIG. 2, on the 360 VR display device, and thus a step is to be performed, in which the 360 VR terminal receives the direction that the 360 VR display device is facing in the virtual space (the gaze direction G). The gaze direction G is defined by a direction from a view point P, which is a center of the spherical virtual space illustrated in FIG. 2, to the spherical screen S that the user faces in order to view the same. When a HMD (head mounted display) is used as the 360 VR display device, a direction set by adjusting a user's head after the user has put on the HMD on the face may be the gaze direction G. When a mobile device including a touch screen S as a display is used, a direction adjusted by user's touches on the touch screen S may be the gaze direction G.

After the gaze direction G is set, the 360 VR terminal displays the video data and an advertisement object on the 360 VR display device in step (d) (S400). A step of displaying video data on the 360 VR display device is similar to a method of displaying a 360 VR video according to the related art. The 360 VR terminal renders video data on the spherical screen S, and displays an image corresponding to a display area D corresponding to the gaze direction G received in step (c), on the 360 VR display device. If an advertisement object having advertisement coordinates that are included in the display area D is present, the 360 VR terminal also displays advertisement contents 11, 12, and 13 of the advertisement object on the 360 VR display device by placing the advertisement contents 11, 12, and 13 at the advertisement coordinates. If no advertisement coordinates are present in the display area D, no advertisement object is displayed, and just video data is displayed on the display area D.

When the display area D is moved as the user controls the 360 VR terminal to modify the gaze direction D, the 360 VR terminal displays advertisement objects having advertisement coordinates included in the display area D, on the 360 VR display device in real time. the advertisement contents 11, 12, and 13 of the advertisement objects may be shown on the 360 VR display device or may disappear therefrom according to the gaze direction D adjusted by the user. When advertisement contents in which a user is interested appear on a screen when watching video data by controlling the 360 VR terminal, the user may fix the gaze direction G and continue to view the advertisement contents 11, 12, and 13. If advertisement contents 11, 12, and 13 in which the user is not interested are displayed on the 360 VR display device, the user may adjust the gaze direction S to make the advertisement contents 11, 12, and 13 to disappear from the screen. As the user controls the gaze direction G by adjusting the 360 VR terminal as described above, interaction between the user and the advertisement contents 11, 12, and 13 displayed on the 360 VR display device is enabled. For example, when the user controls the gaze direction G so as to make an advertisement content to be displayed on the 360 VR display device for five seconds or longer, the 360 VR display device may be set to be moved to a link included in the advertisement content and connected to a website from which products corresponding to the advertisement content may be purchased. The present invention may be applied to enable interaction between the user and advertisement content also in other various manners.

The advertisement contents 11, 12, and 13 may be displayed with the video data in step (d) by using various methods. The 360 VR terminal may overlap the advertisement contents 11, 12, and 13 and an image of the video data with each other and display the overlapped images on the 360 VR display device. Alternatively, the 360 VR terminal may display a video and the advertisement contents 11, 12, and 13 such that the advertisement contents 11, 12, and 13 are visible over an image of the video data. Alternatively, the 360 VR terminal may display a video and the advertisement contents 11, 12, and 13 such that the advertisement contents 11, 12, and 13 are protruded from an image of video data.

When an advertisement object stored in step (b) is defined as a value that varies over time, in step (d), the advertisement object is displayed on the spherical screen S while moving its positions. When a moving piece of advertisement content appears on the display area D, the user may view an advertisement object of interest of the user by adjusting a gaze direction according to the movement of the advertisement content.

In step (d), whether coordinates of an advertisement object exist within the display area D or not may be determined using various methods. The 360 VR terminal may set an area of the spherical screen S within a predesignated angle range (angle of view) with respect to the point of view P around the gaze direction G, as the display area D, and display video data and the advertisement contents 11, 12, and 13 within the display area D using the 360 VR display device. In this case, the viewing angle may be separately received and stored in the 360 VR terminal, or a unique viewing angle may be set for each 360 VR display device for each 360 VR terminal. If a viewing angle of the 360 VR display device is adjustable by the user in real time, a display area D may be set within a range of the viewing angle by determining the viewing angle in real time, thereby displaying video data and the advertisement contents 11, 12, and 13 within the display area D.

Next, from among the advertisement objects, the 360 VR terminal stores an identification number of an advertisement object displayed on the 360 VR display device and exposed to the user in step (e) (S500). When advertisement coordinates of an advertisement object continue to stay in the display area D for a preset period of time or longer, the 360 VR terminal may determine that the advertisement object is exposed to the user and stores an identification number of the advertisement object. According to circumstances, the 360 VR terminal may measure a period of time during which an advertisement object is displayed on the display area D (a period during which the advertisement object is exposed) and store the period of the time according to the identification number of the advertisement object. By using the above-described method, a degree that each advertisement object is exposed to a user may be quantitatively determined and may be used in charging advertising fees to advertisers or for other purposes. For example, advertisement content with a relatively high exposure ratio to a user may be analyzed to select target advertisement that is focused on the taste and interest of users in real time and display the target advertisement on the 360 VR terminal.

While the present invention has been described with reference to preferred embodiments above, the scope of the present invention is not limited to the embodiments described and illustrated above.

For example, while step (e), in which a degree that each advertisement object is exposed is stored, is described as being performed above, according to circumstances, step (e) may be omitted in the method of displaying an advertisement of a 360 VR video according to the present invention. According to the present invention, advertising effects may be increased just by displaying an advertisement object on the 360 VR terminal as described above without performing step (e) of separately storing the degree of exposure of each advertisement object.

While this invention has been particularly shown and described with reference to various embodiments thereof, the present invention should not be construed as being limited to the embodiments set forth herein; various changes, combinations, and modifications may be made therein without departing from the spirit and scope of the present invention as defined by the appended claims.

What is claimed is:

1. A method of displaying an advertisement of a 360 VR (virtual reality) video including an advertisement, by using a 360 VR terminal including a 360 VR display device, the method comprising:
(a) storing video data in a 360 VR format that is displayable on a virtual spherical screen;
(b) storing, as advertisement information, identification numbers of advertisement objects, advertisement contents corresponding to the identification numbers, and advertisement objects defined by advertisement coordinates on the spherical screen, on which the advertisement contents are to be displayed;
(c) receiving a gaze direction that the 360 VR display device faces with respect to the spherical screen, from the 360 VR display device; and
(d) rendering the video data on the spherical screen to display an image corresponding to a display area corresponding to the gaze direction received in (c), on the 360 VR display device, and displaying advertisement content of an advertisement object having advertisement coordinates located in the display area in locations corresponding to the advertisement coordinates, on the 360 VR display device.

2. The method of claim 1, wherein in (d), the advertisement content and an image of the video data are overlapped with each other to be displayed on the 360 VR display device.

3. The method of claim 1, wherein in (d), the video data and the advertisement content are displayed on the 360 VR display device such that the advertisement content is visible over an image of the video data.

4. The method of claim 1, wherein in (d), the video data and the advertisement content are displayed on the 360 VR display device such that the advertisement content is protruded from an image of the video data.

5. The method of claim 1, wherein in (d), the video data and the advertisement content are displayed on the 360 VR display device by setting an area of the spherical screen within a predesignated angle range with respect to the gaze direction, as the display area.

6. The method of claim 1, wherein in (d), an area of the 360 VR display device within a range of a viewing angle is predesignated as the display area.

7. The method of claim 1, wherein in (b), advertisement coordinates of some of advertisement objects of the advertisement information are set to values that vary over time.

8. The method of claim 1, further comprising (e) determining the advertisement content as being exposed if advertisement coordinates of the advertisement object continue to stay within the display area during a predetermined period of time or longer and storing an identification number of the advertisement object.

9. The method of claim 8, wherein in (e), a period of time during which the advertisement object is exposed is further stored.
